(19) United States
(12) Patent Application Publication
(10) Pub. No.: US 2004/0010805 A1
(43) Pub. Date: Jan. 15, 2004

(54) Method and system for remote video display through a wireless projector

(76) Inventors: Ira Dvir, Tel Aviv (IL); Yoav Medan, Haifa (IL)

Correspondence Address: Anthony Castorina, G E Erlich (1995) Ltd, Suite 207, 2001 Jefferson David Highway, Arlington, VA, 22202, US

(21) Appl. No.: 10/399,227

(22) PCT Filed: Oct. 15, 2001
(86) PCT No.: PCT/IL01/00952

(51) Int. Cl. H04N 7/18; H04N 7/173; H04N 7/16

(52) U.S. Cl. 725/136; 725/81; 725/133; 725/141

(57) ABSTRACT

A system and method for transmitting presentation data from a controlling computer to a remote projector through a wireless connection, such that the controlling computer is not connected to the remote projector by a wire or cable, or other physical transmission medium. The presentation data may optionally include text, graphic images, video and/or audio data, and is created at the controlling computer. The controlling computer then transmits the presentation data to the remote projector, which displays the presentation data to an audience.

### FIELD AND BACKGROUND OF THE INVENTION

The present invention relates to a system and method for displaying video and/or audio data through a remote projector, and in particular, to such a system and method in which the remote projector is connected to the source of the data through a wireless connection. The data is preferably compressed before being transmitted to the remote projector.

Computers are becoming more popular as home entertainment devices and for the organization and display of information for the consumer. In addition to the functions of earlier computers, computers today can play music stored in a variety of formats, including files stored in the MP3 format on a CD, on magnetic storage medium or on the DVD storage medium, as well as displaying video streams and enabling “chats” to take place through the Internet. In addition, consumers can now perform a variety of tasks “on-line” through the computer, such as order groceries from the local supermarket, which are then delivered to the house of the consumer. These applications have the advantage of being more efficient and of saving the consumer time.

The computer itself has been sufficiently adapted for the household environment and for the new multi-media tasks, except for portability. The typical household computer is a “desktop” computer which is not very portable. However, certain applications such as playing and managing a musical database or otherwise interacting with the computer from a remote location would be more efficient if the computer could easily be moved from room to room. Thus, desktop computers are not sufficiently portable for such tasks.

Beyond the use of desktop computers for home operation, computers are also currently being used for controlling the display of a presentation, which may optionally include textual information as for slides; video data; audio data; or a combination thereof. A computer can be used for displaying such a presentation by connecting the computer to a projector with a cable. The computer then controls the display of the presentation by sending data to the projector. Again, desktop computers are not sufficiently portable for such an application, and even portable or “laptop” computers still require the use of a connecting cable. Thus, the computer must be in close proximity to the projector, which can be inconvenient, particularly if the operator of the computer wishes to preview the presentation before it is displayed.

A more useful solution would obviate the requirement for a connecting cable. In addition, such a solution would enable the operator of the presentation to view the display of the monitor of the computer for video data, and/or to also be able to hear the audio data, for interacting with the computer at a remote location. The entire computer would therefore not need to be moved to be in close proximity to the projector.

The remote computing device disclosed and claimed in U.S. patent application Ser. No. 09/197,441, incorporated by reference as if fully set forth herein, overcomes these problems by providing a fully remote, independently operatable device for displaying information on the monitor of a remote mobile platform and for controlling the CPU (central processing unit) of the remote computer. However, in order to be fully practicable and realizable, the disclosed device must be able to project the presentation data to an audience. In addition, the disclosed device must receive video data sufficiently rapidly in order for the monitor display to be rapidly refreshed, and to receive the audio stream data rapidly for playing such data through speakers in a responsive manner, without requiring the user to wait for long periods of time between requesting the display of a particular type of information and the actual display thereof.

Currently available technologies for transmitting such video data to, and receiving such video data by, a remote monitor, particularly for such a device which is not connected to the controlling CPU through a wire or cable network, are limited in terms of the amount of bandwidth. Such a limitation is typically 100-1,600 Mbps. Therefore, multimedia data compression methods are required in order to compress a larger amount of data into the bandwidth available for transmission. However, current multimedia data compression methods are most efficient when adjusted for the type of multimedia data being transmitted. If a particular device routinely transmits a certain type of multimedia data, then the compression method is fairly simple to determine, as this method could be adjusted to the type of multimedia data. For devices and applications in which multiple types of multimedia data are transmitted, the compression method must be determined separately for each type of data.

The remote monitor of U.S. patent application Ser. No. 09/197,441 is an example of a device which must routinely receive multiple different types of video data. All of the display data which is received by this remote monitor is video data, but could range from a display of a GUI (graphical user interface) for a word processing software program, to streaming video data for a DVD movie. Each different type of display data therefore requires a different type of video data compression method for the most efficient compression of the transmitted data.

Currently, each multimedia data compression method must be manually adjusted for the particular type of multimedia data. Clearly, such manual adjustments are not suitable for the remote monitor device, which may rapidly display multiple types of multimedia data. Therefore, a better solution would enable the type of multimedia data compression method to be automatically selected according to the type of multimedia data which is to be displayed on the remote monitor. Unfortunately, such a solution is not currently available.

Therefore, there is an unmet need for, and it would be highly useful to have, a method and a system for transmitting presentation data, optionally including text, video and/or audio data, from a controlling computer at a remote location to a projector through a wireless connection, such that the controlling computer is not connected to the projector with a wire or cable, preferably with compression of the presentation data for greater speed and efficiency of transmission.

### SUMMARY OF THE INVENTION

The present invention is of a system and method for transmitting presentation data from a controlling computer to a remote projector through a wireless connection, such that the controlling computer is not connected to the remote projector by a wire or cable, or other physical transmission medium. The controlling computer transmits the presentation data to the remote projector, which displays the presentation data to an audience. According to preferred embodiments of the present invention, the presentation data is also sent to a computer monitor, for display to the operator of the presentation. In addition, preferably the presentation data is compressed according to a method for multimedia data compression, which enables the presentation data to be rapidly and efficiently transmitted to the remote projector.

According to the present invention, there is provided a system for displaying a presentation to an audience, the presentation being composed of data transmitted through a wireless medium, the system comprising: (a) a controlling computer for creating the presentation data for the presentation, the controlling computer including a wireless transmitter for transmitting the presentation data and the controlling computer being characterized as featuring a CPU (central processing unit), the wireless transmitter forming a portion of the wireless medium; and (b) a remote projector for receiving the presentation data and for projecting the presentation data for displaying the presentation to the audience, the remote projector including a wireless receiver for receiving the presentation data from the controlling computer and the remote projector being characterized as lacking a CPU, the wireless receiver forming another portion of the wireless medium.

According to another embodiment of the present invention, there is provided a method for displaying a presentation to an audience, the presentation being composed of presentation data transmitted through a wireless medium, the method comprising the steps of: (a) providing a remote projector for displaying the presentation data to the audience, the remote projector being connected to the wireless medium for receiving the presentation data, the remote projector being characterized by lacking a CPU (central processing unit); (b) transmitting the presentation data to the remote projector through the wireless medium; and (c) displaying the presentation data by the remote projector.

Hereinafter, the term “computer” indicates any type of electronic device which is capable of performing computations, including, but not limited to, personal computers (PC) having an operating system such as DOS, Windows™, OS/2™ or Linux; Macintosh™ computers; computers having JAVA™-OS or BeOS™ as the operating system; thin client computers; and graphical workstations such as the computers of Sun Microsystems™ and Silicon Graphics™, and other computers having some version of the UNIX operating system such as AIX™ or SOLARIS™ of Sun Microsystems™; a PalmPilot™, a PilotPC™, or any other handheld device, portable device for data processing such as a PDA (personal data assistant), or embedded system or device; or any other known and available operating system and computational device. Hereinafter, the term “Windows™” includes but is not limited to Windows95™, Windows 3.x™ in which “x” is an integer such as “1”, Windows NT™, Windows98™, Windows CE™, Windows2000™, and any upgraded versions of these operating systems by Microsoft Corp. (USA).

The method of the present invention could also be described as a plurality of instructions being performed by a data processor, such that the method of the present invention could be implemented as hardware, software, firmware or a combination thereof. For the present invention, a software application could be written in substantially any suitable programming language, which could easily be selected by one of ordinary skill in the art. The programming language chosen should be compatible with the computer according to which the software application is executed. Examples of suitable programming languages include, but are not limited to, C, C++ and Java.

Hereinafter, the term “CPU” (central processing unit) includes those portions of the computer which control the remainder of the computer, including the peripherals. As defined herein, the CPU includes the control unit and the arithmetic and logic unit (ALU), as well as other components such as memory and temporary buffers which are required for the operation of the control unit and the ALU. Other types of microprocessors or data processors are specifically excluded from the term “CPU” as herein defined.

Hereinafter, the term “speaker” is defined to include any type of device for producing an audible sound stream for a user, including an earphone.

Hereinafter, a “locally connectable” video card is a video card which is capable of controlling a monitor or other display device which is attached to the computer in which the video card is located, regardless of whether the computer actually has such a monitor or other display device attached.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A is a schematic block diagram illustrating an exemplary system according to the present invention for compressing video or multimedia data, while FIG. 1B is a flowchart of an exemplary method for analyzing the data;

FIG. 2 is a schematic block diagram illustrating an exemplary wireless multimedia platform monitor according to the present invention;

FIGS. 3A-3C are schematic block diagrams which illustrate three different embodiments of a complete wireless system according to the present invention; and

FIG. 4 is a schematic block diagram of an exemplary remote projection system according to the present invention.

### DESCRIPTION OF THE PREFERRED EMBODIMENTS

The present invention is of a system and method for transmitting presentation data from a controlling computer to a remote projector through a wireless connection, such that the controlling computer is not connected to the remote projector by a wire or cable, or other physical transmission medium. The presentation data may optionally include text, graphic images, video and/or audio data, and is created at the controlling computer. The controlling computer then transmits the presentation data to the remote projector, which displays the presentation data to an audience.

According to preferred embodiments of the present invention, the presentation data is also sent to a computer monitor, for display to the operator of the presentation. Optionally, such a display may be restricted to the computer monitor, for example if the operator of the presentation wishes to preview the presentation before it is shown to the audience. The computer monitor may be connected to the controlling computer with a wire or cable, but preferably also receives the presentation data through a wireless connection. Thus, optionally the computer monitor, the controlling computer and the remote projector are located at three separate physical locations, and are preferably connected through a wireless connection.

According to other preferred embodiments of the present invention, the presentation data is compressed according to a method for multimedia data compression, which enables the presentation data to be rapidly and efficiently transmitted to the remote projector. The method of multimedia data compression according to the present invention adjusts the compression method according to the type of software application which generated the multimedia data, and hence according to the characteristics of the data itself. Preferably, the type of multimedia data compression is selected by a profile manager, which detects the characteristics of the multimedia data to determine the character of the data, and then which selects the multimedia data compression profile, including the compression method according to the character of the data.

The principles and operation of the system and method according to the present invention may be better understood with reference to the drawings and the accompanying description.

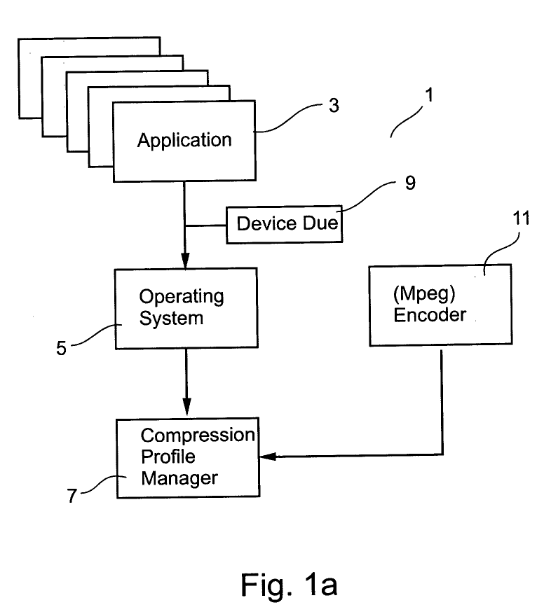

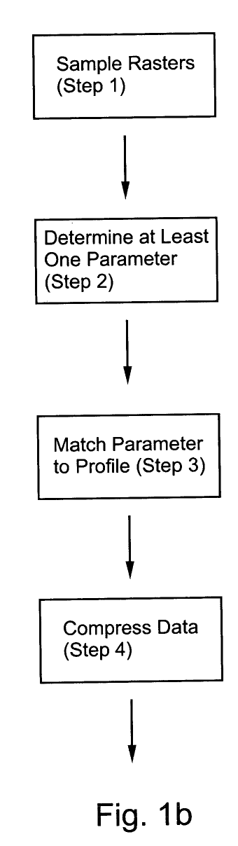

Referring now to the drawings, FIG. 1A is a schematic block diagram illustrating an exemplary system according to the present invention, while FIG. 1B is a flowchart of an exemplary method according to the present invention. Although FIGS. 1A and 1B are drawn toward video compression methods, it is understood that this is for the purposes of description only, without any intention of being limiting in any way.

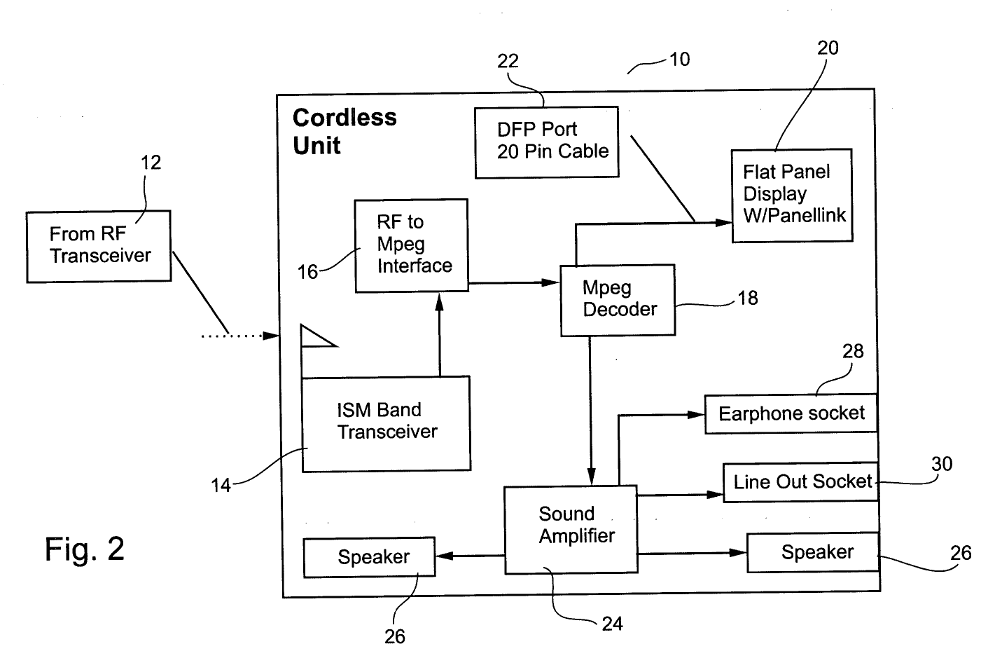

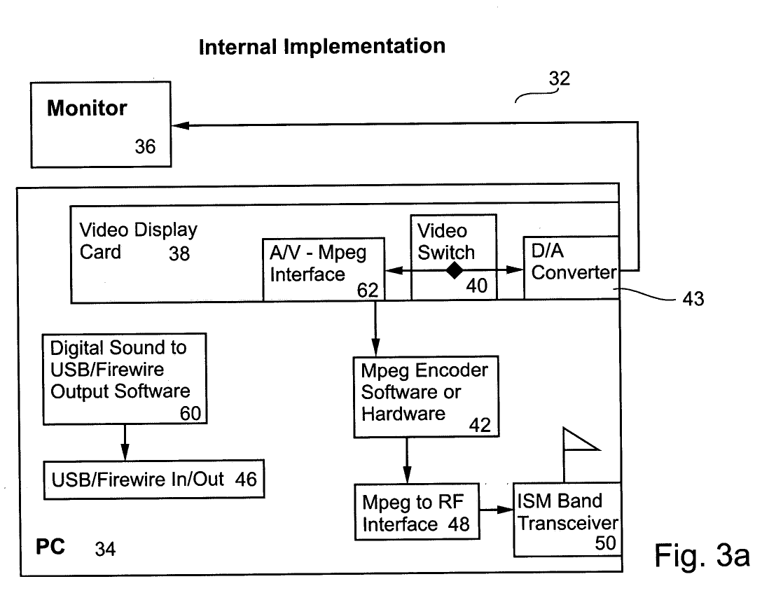

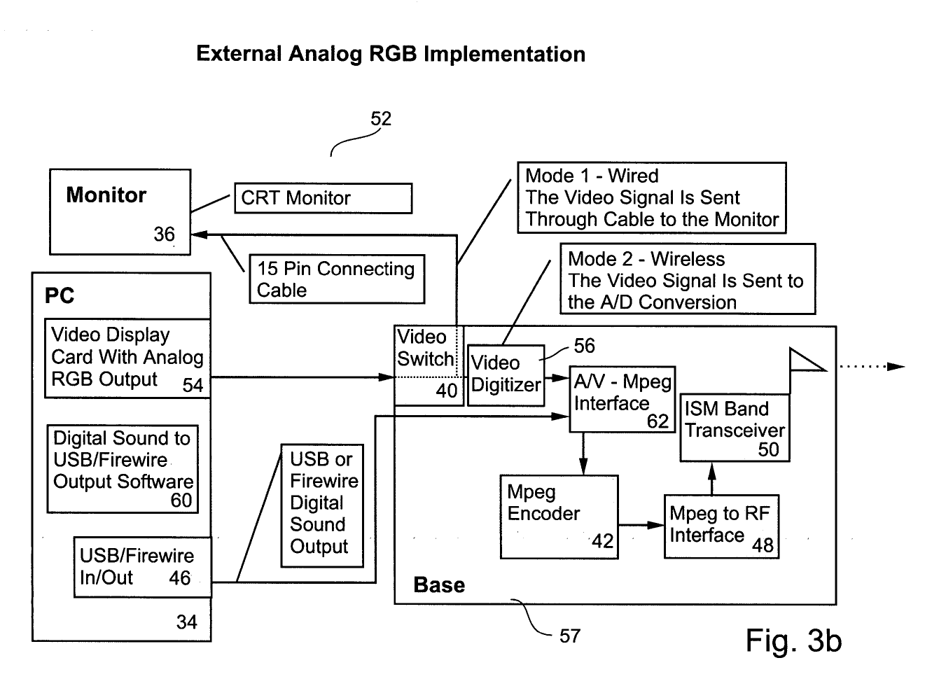

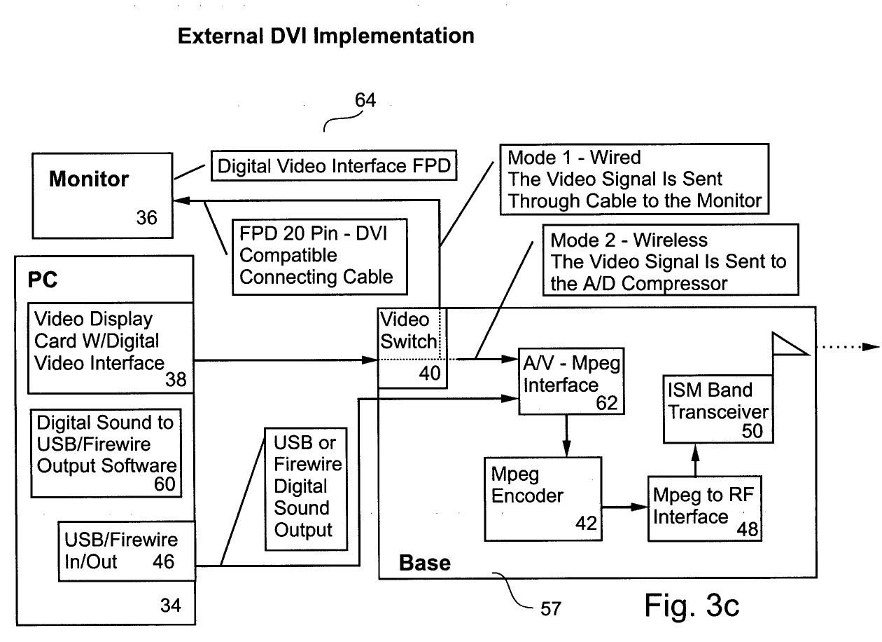

As shown in FIG. 1A, a system 1 features a plurality of software applications 3 for producing different types of display data. Software applications 3 are operated by an operating system 5. The display data must be compressed according to a suitable video compression method before transmission decompression and display, for example by the remote monitor of FIG. 2, and for the systems of FIGS. 3A-3B.

In order for the data to be suitably compressed, the video compression method must be selected to be compatible with the particular type of data produced by each software application 3. Therefore, operating system 5 feeds the display data to a compression profile manager 7. The process is controlled by a separate reporting device driver 9, for causing operating system 5 to report the type of each software application 3 which is running to compression profile manager 7. Preferably, reporting device driver 9 also causes operating system 5 to report the screen resolution to compression profile manager 7.

Once compression profile manager 7 has received the pertinent information concerning the type of video display data which is being produced, compression profile manager 7 can select the particular type of video compression method for compressing the display data. Compression profile manager 7 has a plurality of compression profiles, each of which is suitable for a particular type of display data which is produced by a particular software application 3. As each type of display data is passed from operating system 5, compression profile manager 7 selects a suitable compression profile for compressing the video data, according to the characteristics of the display data, as described in greater detail with regard to FIG. 1B. Alternatively, the user can manually select a compression profile from a plurality of such profiles provided by compression profile manager 7.

Once the proper compression profile for the display data is selected, the actual process of compression is performed by an MPEG (Motion Picture Expert Group) encoder 11 or other type of compression algorithm. It is understood that although the present invention is described with regard to a particular type of video data compression method, namely the MPEG group of compression methods, this is only for the purposes of description and is not intended to be limiting in any way.

For example, different compression profiles would be required for television video stream, a word processing screen stream, a three-dimensional video game video stream, and so forth. Preferably, an automatic video content analysis method would be employed to analyze the type of video data and would select a particular compression profile according to the type of video data. A preferred implementation of such an automatic method is given in FIG. 1B. In step 1, the video data to be transmitted is analyzed. For example, groups of rasters of the video data are optionally sampled for analysis. Preferably, each such group is a block of 8×8 pixels.

In step 2, at least one parameter is determined for each sample. Preferably, the parameter includes, but is not limited to, a number of unique colors in the screen, a presence of static dark thin rows of pixels or large static blocks, and a level of motion in the screen between one frame and the next frame. More preferably, a plurality of such parameters is analyzed.

In step 3, the plurality of parameters is matched to a particular compression profile, which is then selected by compression profile manager 7. For example, the presence of thousands of unique colors in a frame with considerable movement between frames, as well as unchanged black stripes at the bottom and top of each frame, would indicate that a DVD movie is being transmitted. The appropriate compression profile for the DVD movie would then be selected.

The compression profile would be adjusted according to such factors as the maximum resolution, refresh rate and color handling. Optionally and preferably, for text data, a variable bit rate is used for the compression, since the amount of text data which must be transmitted at any particular moment is itself variable. Therefore, the MPEG compression methods are preferred for the present invention as they feature different profiles and levels which are adjusted according to these different factors. The MPEG encoder is also preferred as it enables noise to be filtered through different “filters”, such as low-pass, median and deinterlacing filters. The motion vector may also be set, for example by enlarging or minimizing the search area of the data which has changed position within the frame.

Regardless of the level and profile, the MPEG format uses three different types of frames: I, B and P frames. The I frame is the initial or “intra-frame” and is required. The B frame is a bi-directional frame, while the P frame is a predictable frame. The B and P frames are optional, and B frames can be removed without P frames.

These different types of frames are organized into groups. For example, a video stream compressed according to the MPEG method could feature a 3 frame group, such as IBP for example, or a 9 frame group, such as IBBPBBPBB for example, or even a 12 frame group, such as IPPPPPPPPPPP for example. In each group, there is a single I frame, while the number of B and P frames in each group may vary, or even may be deleted altogether. In addition, the number of frames per second, the motion vectors, the resolution, and the filters, may all optionally be adjusted in order to produce each compression profile.

An exemplary compression profile for a television video stream would feature a main level, main profile MPEG-2 compression method with frame groups of 12 frames: IBB PBB PBB PBB. The method would feature progressive encoding, or deinterlacing, and low pass filtering. The motion vectors would be 32×32 for the P frames and 16×16 for the B frames.

On the other hand, an exemplary compression profile for a word processing screen stream at a 800×600 resolution would be high profile, high level variable MPEG-2 stream with frame groups of 9 frames: IBB PBB PBB. In cases where flawless quality is necessary all of the B frames could be omitted, such that a rate of 30 frames per second becomes a rate of 10 tripled frames per second. The motion vectors are 24×24 for the P frames and 8×8 for the B frames. No filters are applied.

For the 3-D video game video data, an exemplary compression profile would optionally feature a high profile, high level MPEG-2 compression method at 60 frames per second, thereby halving the delay caused by the compression process itself Preferably, the compression method would feature groups of 18 frames: IBPBPBPBPBPBPBPBPB. All of the B frames are deleted, such that a frame rate of 60 frames per second becomes a rate of 30 doubled frames per second. The motion vectors are 48×48 for the P frames and 8×8 for the B frames.

In step 4, the compression profile is set to determine the particular video compression method for compressing the video data. The data is then compressed and transmitted.

Of course, the previously described system and method could be extended to other types of multimedia data, such as audio stream data for example. Alternatively, as previously described, the compression profile could be manually selected by the user, or alternatively could be determined automatically according to the identity of the software application which is producing the video data and/or other types of multimedia data. Two or more of the elements of automatic analysis according to a software module or other set of electronically executed instructions, manual selection by the user, and selection according to the identity of the software application which produces the multimedia data, can also optionally be combined. Optionally and most preferably, the user is able to manually override any automatically selected compression profile, and to replace such an automatically selected compression profile with a different compression profile. Preferably, such a replacement is enabled through a GUI (graphical user interface) element, preferably with the use of a macro command. A ruler or other display of macro buttons such as “tv” “dvd” “text” or “graphics” could be used for controlling these macro commands.

FIG. 2 is a schematic block diagram illustrating an exemplary wireless monitor according to the present invention, for displaying the multimedia data from the computer (not shown), preferably including at least video data and audio data, and more preferably including video and audio data together. The wireless monitor is optionally and preferably used with the detached computers for decompressing the multimedia data according to the present invention, which include various components for compressing the data before transmission to the wireless monitor, preferably according to the system and method of FIGS. 1A and 1B, respectively.

A wireless monitor 10 is connected to a radiofrequency (RF) transceiver 12, which communicates with a main computer (not shown) through radiowave communication. Wireless monitor 10 preferably displays both audio and visual data, although wireless monitor 10 could optionally display only audio or only visual data. Hereinafter, the term “display” can include both a visual display and an audio display.

Wireless monitor 10 preferably includes an ISM band transceiver 14 for receiving radiowave communication from the main computer, and for transmitting such radiowave communication to the main computer. More preferably, all of the radiowave receivers and transmitters of the present invention operate as low-frequency radiowaves, most preferably in the range of from about 2.4 GHz to about 5.8 GHz, as this range does not require a special license in the United States of America.

ISM band transceiver 14 is preferably connected to a radiofrequency conversion interface 16, for converting the radiowaves to video stream data. Preferably, conversion interface 16 converts the radiowaves to such video data in the MPEG format, although of course a different format could alternatively be used. The data is then decoded by a decoder 18, which provides the video portion of the data to a display screen 20. Optionally and preferably, display screen 20 receives this data through a DFP (digital flat panel display) port 22. Also optionally and preferably, display screen 20 is a flat panel display, although of course other types of display screens could also be used. Examples of display screen 20 include but are not limited to any type of flat screen including a plasma screen or an LCD (liquid crystal display), a CRT (cathode ray tube) monitor, a computer monitor or any other type of video display monitor. Thus, wireless monitor 10 enables visual data such as a GUI (graphical user interface), other graphics or images, or a video stream, to be displayed to the user.

Decoder 18 also optionally and preferably provides the audio portion of the decoded data to a sound amplifier 24. Sound amplifier 24 is connected to some type of audio playing device, such as a speaker 26, an earphone socket 28, or a line-out socket 30 as shown.

Preferably, wireless monitor 10 receives power through a battery which is optionally chargeable at a charger/base (not shown), thereby enabling wireless monitor 10 to be portably transported for displaying video and/or audio data at various remote locations.

FIGS. 3A-3C are schematic block diagrams of exemplary configurations of wireless monitor 10 and a main computer for communicating with wireless monitor 10 of FIG. 2 in order to provide the multimedia data, such as video and/or audio data for display by wireless monitor 10. These configurations preferably perform the method for compression of multimedia data according to the present invention, as described with regard to FIGS. 1A and 1B.

FIG. 3A shows a first exemplary system 32 which is an internal implementation, in which the components of the multimedia compression system are contained within a main computer 34. As shown, main computer 34 is connected to the wireless monitor (not shown) and to a local monitor 36, which is optionally connected to main computer 34 with a cable. Main computer 34 features a video display card 38 with DVI (digital output) or DSP, which is connected to a video switch 40. In the embodiment shown, video switch 40 is contained within main computer 34, and is preferably connected to both local monitor 36 and to an MPEG encoder 42, such that the video signals are either displayed locally, at local monitor 36, or else are encoded for remote transmission by MPEG encoder 42. For local display at local monitor 36, preferably the signals are fed through a D/A converter 43.

It should be noted that MPEG encoder 42, which may be embodied as software, firmware or hardware, may encode the video data according to a different data format. MPEG encoder 42 optionally and preferably receives the video signals from an A/V-MPEG interface 62, which is more preferably located on video display card 38, and which converts the video signals from a format which is suitable for video display card 38 to a format which is suitable for MPEG encoder 42.

MPEG encoder 42 also optionally and preferably receives audio input from an audio encoder 44, which converts the audio data into a format which is readable by MPEG encoder 42. MPEG encoder 42 then transmits the combined audio and video data to a converter 48. Converter 48 converts the combined data into radiowaves, which are then transmitted by an ISM band SP² transmitter 50 for transmitting radiowaves to the wireless monitor (not shown).

In addition, the audio data is passed as digital audio signals to a USB and/or Firewire output device driver 60, which sends the audio data to a USB and/or Firewire port 46 for combining with the video data to converter 48.

A system 52 shown in FIG. 3B is similar to that of FIG. 3A, except that the implementation is now external to main computer 34, and a video display card 54 now has an analog RGB output directly to video switch 40. Video switch 40 and the other multimedia compression and transmission components are now located at a separate base 57, which is separate from main computer 34.

Video switch 40 passes the analog video data to a video digitizer and converter 56, which passes the data to A/V-MPEG interface 62. MPEG interface 58 passes the data to MPEG encoder 42, and from there to converter 48 and transceiver 50, as previously described.

As for FIG. 3A, the audio data is passed as digital audio signals to a USB and/or Firewire output device driver 60, which sends the audio data to a USB and/or Firewire port 46 for combining with the video data at A/V-MPEG interface 62.

FIG. 3C shows a system 64 which is a second external implementation, in which the multimedia compression and transmission components are also located at separate base 57. However, these components are now implemented for digital video signals, as for FIG. 3A, rather than for the analog signals of FIG. 3B.

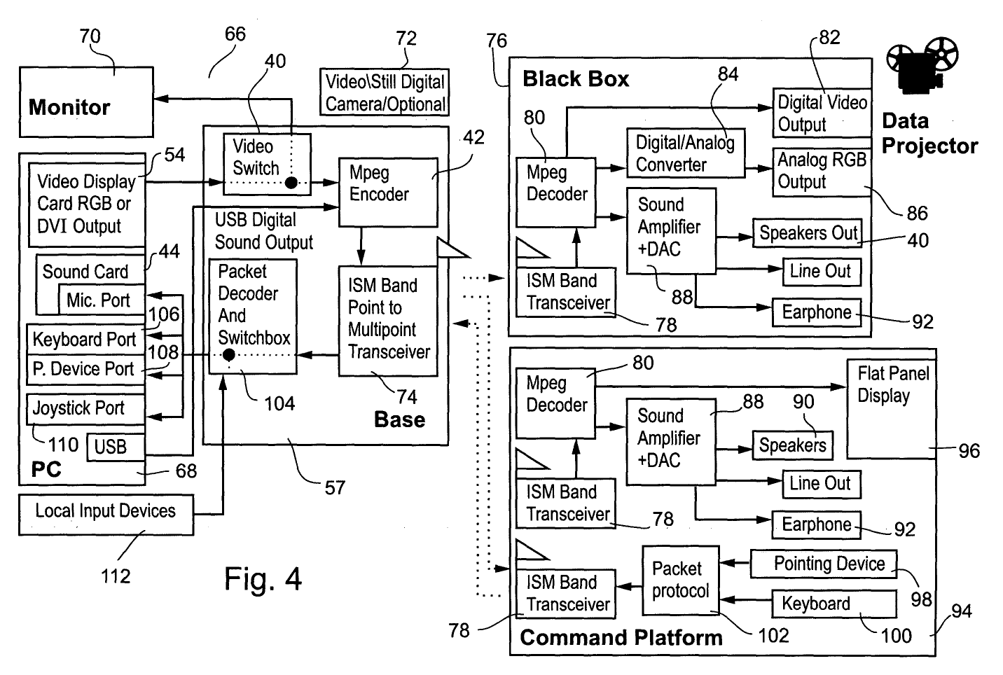

FIG. 4 is a schematic block diagram of an exemplary system for projecting presentation data to an audience by a remote projector. Those components of FIG. 4 which have identical reference numbers as for components shown in FIGS. 3A-3C are assumed to have an identical function. The wireless connection between the computer which transmits the presentation data, and the remote projector which receives and displays the data, can also be termed a “wireless medium”, as the connection does not involve a physical medium or component such as a wire or cable, for example.

As shown, a system 66 features a controlling computer 68, for preparing the presentation data and for controlling the presentation. As previously described, the presentation data is optionally one or more of text, graphic image, video and/or audio data, and any combination thereof, optionally or alternatively with any other type of data for presentation to an audience. Controlling computer 68 may optionally have an associated monitor 70, which is optionally connected to controlling computer 68 with a cable. Controlling computer 68 features video display card 54 with an analog RGB output directly to video switch 40. Alternatively, DVI (digital output) could be used. If the analog output is used, then video display card 54 would also need to have an associated video digitizer and converter (not shown).

Video switch 40 is located at separate base 57, which is separate from controlling computer 68. Video data is received by video switch 40, and is passed to MPEG encoder 42. MPEG encoder 42 also optionally and preferably receives video and/or still image data from a video and/or still image camera 72. MPEG encoder 42 also optionally and preferably receives audio input from audio encoder 44, which converts the audio data into a format which is readable by MPEG encoder 42. MPEG encoder 42 then transmits the combined audio and video data to converter 48. Converter 48 converts the combined data into radiowaves, which are then transmitted by an ISM band SP² transceiver 74 for transmitting radiowaves to at least a wireless projector 76. ISM band SP² transceiver 74 is preferably implemented as a point to multipoint transceiver. ISM band SP² transceiver 74 forms a portion of the wireless medium.

Wireless projector 76 is optionally located at a remote location from controlling computer 68, but does not require a physical connection, such as a wire or cable, to controlling computer 68. Instead, an ISM band SP² transceiver 78 receives radiowaves from base 57. ISM band SP² transceiver 78 forms another portion of the wireless medium. The data is then decoded with an MPEG decoder 80. If the decoded data is digital video data, it is preferably sent to a digital video output device 82 for projection to the audience. If the decoded data is analog video data, it is preferably sent to a digital/analog converter 84, before being given to an analog RGB video output device 86 for projection to the audience. If the decoded data is sound data, it is preferably sent to a sound amplifier 88, before being given to a sound output device 90 for projection to the audience. Optionally, the sound data is also sent for output to earphones 92.

Although remote projector 76 may optionally feature a computer or other video monitor for viewing the presentation by the operator (not shown), preferably the operator controls the presentation from a command platform 94. Command platform 94 again features a number of similar to components as remote projector 76; however, instead of projecting the presentation to an audience, preferably the operator is able to view the presentation through a flat panel display 96, and is optionally able to hear the audio data through sound output device 90 and/or earphones 92.

In addition, preferably command platform 94 features a pointing device 98, such as a mouse or other input device, and a keyboard 100, for receiving input such as data and/or commands from the operator. Such input from the operator is highly preferred to enable the operator to fully control the presentation and the activities of controlling computer 68. The input from the operator is converted to packet data by a packet protocol module 102, although it is understood that other types of data transmission formats could be used in place of the packet format.

The packet data is then transmitted by ISM band SP² transceiver 78, which could optionally be the same as that which receives radiowaves from base 57, or alternatively could be a separate component. In any case, ISM band SP² transceiver 78 transmits data to ISM band SP² transceiver 74 at base 57. The packet data is then decoded and separated into the appropriate types of input data by a packet decoder and switchbox 104. Packet decoder and switchbox 104 then determines which input port of controlling computer 68 should receive the data, such as a keyboard port 106, a pointing device port 108, or a joystick port 110. Optionally, one or more local input devices 112 could also be connected to packet decoder and switchbox 104, for example for receiving commands locally at controlling computer 68. Thus, the operator is able to control the function of controlling computer 68, and hence of the presentation, through command platform 94.

According to preferred embodiments of the present invention, the operator may wish to preview the presentation before the audience is able to see it, or otherwise to receive display data from controlling computer 68 without such data being seen by the audience. Therefore, optionally and preferably, the operator is able to determine whether remote projector 76 receives data from controlling computer 68, for example by entering one or more commands through command platform 94. These command(s) then preferably are sent to ISM band SP² transceiver 74 at base 57. ISM band SP² transceiver 74 is more preferably controlled by a set of macros which determine whether data is transmitted to remote projector 76.

According to other preferred embodiments of the present invention, the presentation data would be compressed before transmission to remote projector 76 and/or command platform 94. Optionally and preferably, the previously described compression method could be used. Since the presentation data is expected to include one or more of a relatively narrow set of types of data, the compression method could easily be adjusted to accommodate substantially any type of presentation data which would be expected to be included in the presentation. The preferred use of such compression would reduce the amount of bandwidth which would be required to transmit the presentation data.

A more simple implementation of system 66 would feature a detachable input platform, without a flat panel display (not shown). This input platform would preferably have a separate radio channel, which could also optionally be in the 900 MHz band.

Therefore, the device of the present invention provides a mechanism for projecting data to an audience through a remote projector, as well as complete interactivity with a main computer at a remote location, without necessarily requiring a network card and without a physical wire or cable connection. The interactivity is provided through a remote A/V display device and a remote input platform, both of which lack a CPU. Thus, the main computer controls the actions of the remote A/V display device according to instructions received from the remote input platform.

Furthermore, the method of compressing the audio and/or visual stream data according to the present invention also provides for the rapid transmission of the data, since the type of compression is selected according to the type of application which generated the video stream data, and hence according to the particular characteristics of this data.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for displaying a presentation to an audience, the presentation being composed of data transmitted through a wireless medium, the system comprising:
(a) a controlling computer for creating the presentation data for the presentation, said controlling computer including a wireless transmitter for transmitting said presentation data and said controlling computer being characterized as featuring a CPU (central processing unit), said wireless transmitter forming a portion of the wireless medium; and
(b) a remote projector for receiving the presentation data and for projecting the presentation data for displaying the presentation to the audience, said remote projector including a wireless receiver for receiving the presentation data from said controlling computer and said remote projector being characterized as lacking a CPU, said wireless receiver forming another portion of the wireless medium.

2. The system of claim 1, wherein said controlling computer further comprises:
(i) a video card for formatting visual data for display; and
(ii) a local monitor for displaying said visual data;
and wherein said remote projector further comprises:
(i) a remote projector display for displaying said visual data;
the system further comprising:
(c) a switching box for switching said visual data to said controlling computer to said local monitor and alternately to said remote projector display, said switching box featuring a wireless transceiver for exchanging data with said remote projector.

3. The system of claim 2, wherein said wireless transmitter of said controlling computer forms part of said wireless transceiver of said switching box.

4. The system of claim 2, further comprising:
(d) a command platform for interaction with a user, said command platform comprising:
(i) a wireless transceiver for receiving the presentation data from said controlling computer; and
(ii) a command platform display for displaying said visual data of the presentation data;
said wireless transceiver of said command platform being in communication with said wireless transceiver of said switching box for determining a recipient device for said visual data, such that said visual data is alternately sent to said command platform for display by said command platform display and to said remote projector by display to said remote projector display.

5. The system of claim 4, wherein said command platform further comprises:
(iii) an input device for receiving input from said user, said input being transmitted by said wireless transceiver to said switching box;
wherein said switching box features an input conversion device for converting said input from said command platform to rendered input data;
and wherein said controlling computer further comprises:
(iii) an input device port for receiving said rendered input data, such that said controlling computer performs at least one operation according to said rendered input data.

6. The system of claim 5, wherein said command platform further comprises:
(iv) a packet protocol module for transforming said input data to a packet format;
and wherein said switching box further comprises a packet decoder for decoding said input data from said packet format to said rendered input data.

7. The system of claim 6, wherein said wireless transmitter of said controlling computer is a radiowave transmitter.

8. The system of claim 7, wherein said radiowave transmitter transmits radiowaves in a range of from about 2.4 GHz to about 5.8 GHz.

9. The system of claim 8, wherein said radiowave transmitter is an ISM band transmitter.

10. The system of claim 7, wherein said wireless transceiver of said controlling platform and said switching box are radiowave transceivers.

11. The system of claim 10, wherein said radiowave transceiver operates with radiowaves in a range of from about 2.4 GHz to about 5.8 GHz.

12. The system of claim 11, wherein said radiowave transceiver is an ISM band transceiver.

13. The system of claim 12, wherein said ISM band transceiver of said switching box is a point to multipoint transceiver.

14. The system of claim 5, wherein said command platform display and said local monitor are each separately selected from the group consisting of a plasma screen, a LCD (liquid crystal display) screen, a flat panel display, and a CRT (cathode ray tube) screen.

15. The system of claim 14, wherein the presentation data includes audio data and said remote projector further comprises:
(i) an audio amplifier for amplifying audio signals from said controlling computer; and
(ii) a speaker for audibly displaying said audio signals received from said audio amplifier.

16. The system of claim 5, wherein said input device of said command platform further comprises at least one of a remote keyboard and a remote pointing device.

17. The system of claim 1, wherein said controlling computer compresses the presentation data according to a compression method before transmitting the presentation data to said remote projector, said compression method being selected according to at least one characteristic of the presentation data.

18. A method for displaying a presentation to an audience, the presentation being composed of presentation data transmitted through a wireless medium, the method comprising the steps of:
(a) providing a remote projector for displaying the presentation data to the audience, said remote projector being connected to the wireless medium for receiving the presentation data, said remote projector being characterized by lacking a CPU (central processing unit);
(b) transmitting the presentation data to said remote projector through the wireless medium; and
(c) displaying the presentation data by said remote projector.

19. The method of claim 18, wherein step (b) further comprises the steps of:
(i) providing a controlling computer for preparing the presentation data, said controlling computer featuring a CPU and said controlling computer being connected to the wireless medium;
(ii) preparing the presentation data by said controlling computer; and
(iii) transmitting the presentation data from said controlling computer to said remote projector through the wireless medium.

20. The method of claim 19, wherein step (ii) further comprises the steps of:
(1) providing a plurality of different data compression procedures, each of said compression procedures being associated with a profile of characteristics of the presentation data;
(2) receiving the presentation data to be compressed to form received data;
(3) determining at least one characteristic of said received data;
(4) selecting a profile according to said at least one characteristic; and
(5) compressing said received data according to a compression procedure associated with said profile.
